(19) United States
(12) Patent Application Publication
(10) Pub. No.: US 2026/0288063 A1
(43) Pub. Date: Sep. 24, 2026

(54) TIMEPIECE MOVEMENT AND TIMEPIECE

(71) Applicant: SEIKO WATCH KABUSHIKI KAISHA (trading as SEIKO WATCH CORPORATION), Tokyo (JP)

(72) Inventor: Yuya TANAKA, Tokyo (JP)

(21) Appl. No.: 19/569,587

(22) Filed: Mar. 17, 2026

(30) Foreign Application Priority Data
Mar. 21, 2025 (JP) 2025-046272

(51) Int. Cl. G04B 1/14

(52) U.S. Cl. CPC G04B 1/14

(57) ABSTRACT

To provide a timepiece movement capable of preventing transmission of an excessive torque from a mainspring to an escapement and speed control mechanism and preventing wear of a part without deteriorating an appearance of the movement. The movement includes: a slider spacer disposed to be non-displaceable with respect to a barrel bridge and formed with a guide groove extending along a circumferential direction centered on a rotation axis; a pin inserted into the guide groove and provided to be displaceable along the circumferential direction along the guide groove; a slider disposed along the slider spacer, fixed to the pin, and provided to be rotatable around a central axis with respect to the barrel bridge; a click body provided to be non-displaceable with respect to the slider and including a finger portion meshing with a ratchet wheel; and a click spring provided to be capable of pressing the slider so as to bias the finger portion toward the ratchet wheel.

### RELATED APPLICATIONS

This application claims priority to Japanese Patent application No. JP2025-046272, filed on Mar. 21, 2025, the entire content of which is incorporated herein by reference.

### BACKGROUND OF THE INVENTION

### 1. Field of the Invention

The present invention relates to a timepiece movement and a timepiece.

### 2. Description of Related Art

In the related art, a movement of a mechanical timepiece includes a barrel complete that houses a power mainspring, a ratchet wheel that winds the mainspring, and a winding train wheel that rotates the ratchet wheel. In order to prevent unwinding of the wound mainspring, the ratchet wheel is engaged with a click that restricts reverse rotation of the ratchet wheel. Further, in order to prevent transmission of an excessive torque from the mainspring to an escapement and speed control mechanism, the movement may be provided with a mechanism for loosening the mainspring by reversing the ratchet wheel to some extent when rotation of the ratchet wheel that winds the mainspring is stopped (see, for example, JPS52-166555U). JPS52-166555U discloses a mainspring winding mechanism in which a click that meshes with a ratchet wheel is a gear that swings along an elongated hole formed in a main plate or a bridge by rotation of the ratchet wheel, and the click is stopped from rotating by a stopper at a one-side swing end when the ratchet wheel rotates in one direction.

However, in the mainspring winding mechanism disclosed in JPS52-166555U, when the click moves along the elongated hole by the rotation of the ratchet wheel, the click slides on a side wall surface of the elongated hole at a high speed, and thus the side wall surface of the elongated hole may be worn. On the other hand, when a surface treatment for improving wear resistance is performed on the main plate or the bridge in which the elongated hole is formed, an appearance of the movement may be deteriorated. Therefore, in the timepiece movement that can prevent the transmission of the excessive torque from the mainspring to the escapement and speed control mechanism, there is a problem of preventing wear of a part without deteriorating the appearance of the movement.

### SUMMARY OF THE INVENTION

It is an aspect of the present application to provide a timepiece movement capable of preventing transmission of an excessive torque from a mainspring to an escapement and speed control mechanism and preventing wear of a part without deteriorating an appearance of the movement, and a timepiece including the timepiece movement.

A timepiece movement according to a first aspect of the application includes: a ratchet wheel provided to be capable of winding a mainspring; a barrel bridge configured to support the ratchet wheel to be rotatable around a rotation axis; a slider spacer disposed to be non-displaceable with respect to the barrel bridge and formed with a guide groove extending along a circumferential direction centered on the rotation axis; a guided portion inserted into the guide groove and provided to be displaceable along the circumferential direction along the guide groove; a slider disposed along the slider spacer, fixed to the guided portion, and provided to be rotatable around an axis extending along an axial direction of the rotation axis with respect to the barrel bridge; a click body provided to be non-displaceable with respect to the slider and including a finger portion meshing with the ratchet wheel; and a biasing member provided to be capable of pressing the slider so as to bias the finger portion toward the ratchet wheel.

According to the first aspect, when the ratchet wheel is rotated in winding the mainspring, a force in a rotation direction of the ratchet wheel is applied to the click body via the finger portion. Here, since the click body is provided to be non-displaceable with respect to the slider, as the guided portion is guided by the guide groove and moves in the guide groove, the click body, together with the slider fixed to the guided portion, rotates around the rotation axis in the same direction as the ratchet wheel. When the winding of the mainspring is stopped, a torque in a direction opposite to the rotation direction during the winding acts on the ratchet wheel by a restoring force of unwinding of the mainspring. Then, the ratchet wheel starts to reversely rotate. At this time, along with the reverse rotation of the ratchet wheel, the click body, together with the slider, rotates around the rotation axis in the same direction as the ratchet wheel. In this way, when the winding of the mainspring is stopped, the reverse rotation of the ratchet wheel is allowed by a length of the guide groove together with the rotation of the click body, and thus it is possible to prevent transmission of an excessive torque from the mainspring to an escapement and speed control mechanism.

Since the guide groove that guides the rotation of the guided portion around the rotation axis is formed in the slider spacer, it is possible to prevent sliding contact between a component of the timepiece movement and the barrel bridge when the click body rotates around the rotation axis. Therefore, it is possible to improve the wear resistance of the timepiece movement against the rotation of the click body around the rotation axis without changing a material or performing a surface treatment on the barrel bridge.

Further, since the biasing member presses the slider, shapes of the slider and the biasing member can be determined regardless of a shape of the click body. Accordingly, the slider and the biasing member can be formed in a shape less likely to wear.

With the above, in the timepiece movement that can prevent the transmission of the excessive torque from the mainspring to the escapement and speed control mechanism, it is possible to prevent the wear of the part without deteriorating the appearance thereof.

In addition, since the slider and the click body can be formed into a unit, when the unit is scratched, it is possible to replace a worn part by replacement of the unit without replacing the barrel bridge. Therefore, after-sales service performance can be improved.

A timepiece movement according to a second aspect of the application is the timepiece movement according to the above first aspect, in which the slider and the biasing member may be disposed between the barrel bridge and the slider spacer.

According to the second aspect, a portion where the slider can slide with respect to the barrel bridge and the slider spacer along with the rotation of the slider around the rotation axis is positioned between the barrel bridge and the slider spacer. In addition, a sliding contact portion between the slider and the biasing member is positioned between the barrel bridge and the slider spacer. Accordingly, even when lubrication is performed on the sliding portion between the barrel bridge and the slider and the sliding contact portion between the slider and the biasing member, it is possible to prevent an oil from leaking to an outer surface of the timepiece movement. Therefore, the deterioration of the appearance of the timepiece movement can be prevented.

In addition, since the slider for holding the guided portion is disposed between the barrel bridge and the slider spacer, the slider is prevented from being inclined with respect to the slider spacer and the barrel bridge, and the click body can be prevented from unintentionally coming into sliding contact with the barrel bridge.

Further, since the slider and the biasing member are less likely to be displaced relative to each other in the axial direction by being sandwiched between the barrel bridge and the slider spacer, the slider and the biasing member are less likely to disengage. Therefore, the disengagement of the slider and the biasing member due to an impact applied to the timepiece movement can be prevented.

A timepiece movement according to a third aspect of the application is the timepiece movement according to the above first or second aspect, in which the click body may be disposed on a side opposite to the slider and the biasing member with respect to the barrel bridge in the axial direction.

According to the third aspect, when the click body is disposed on a front side of the barrel bridge, the slider and the biasing member are disposed on a back side of the barrel bridge. Accordingly, since the sliding portion between the slider spacer and the slider and the sliding contact portion between the slider and the biasing member are positioned on the back side of the barrel bridge, it is possible to sufficiently lubricate the sliding portion between the slider spacer and the slider and the sliding contact portion between the slider and the biasing member while preventing the deterioration of the appearance due to the lubrication. Therefore, the wear resistance of the timepiece movement can be further improved.

In addition, since the slider and the biasing member are disposed on the back side of the barrel bridge, it is easy to ensure a finished area on a front side of the barrel bridge, and it is possible to improve an aesthetic appearance of the timepiece movement.

Further, since the biasing member is disposed on a side opposite to the ratchet wheel with the barrel bridge interposed therebetween, the biasing member does not interfere with the ratchet wheel, and the biasing member can be disposed to overlap the ratchet wheel when viewed from the axial direction. Therefore, a degree of freedom in layout of the biasing member can be improved.

A timepiece movement according to a fourth aspect of the application is the timepiece movement according to the above third aspect, in which the guided portion may extend along the axial direction and couple the slider and the click body, the barrel bridge may be formed with a through hole through which the guided portion is inserted, and the through hole may be formed larger than the click body when viewed from the axial direction such that the click body is passable through the through hole along the axial direction.

According to the fourth aspect, in a state where the slider and the click body are formed into a unit, the click body passes through the through hole and can be disposed on a side opposite the slider with respect to the barrel bridge. Therefore, the timepiece movement can be easily assembled and disassembled.

A timepiece movement according to a fifth aspect of the application is the timepiece movement according to any one of the above first aspect to fourth aspect, in which the guided portion may extend along the axial direction and couple the slider and the click body, one of the click body and the slider may be formed with a positioning hole penetrating the axial direction at a position shifted from the guided portion in a direction orthogonal to the axial direction, and the other of the click body and the slider may be formed with a positioning recess opening toward the positioning hole and overlapping the positioning hole when viewed from the axial direction.

According to the fifth aspect, when the click body and the slider are to be coupled to each other via the guided portion, the positioning hole and the positioning recess overlap each other when viewed from the axial direction, so that the click body and the slider can be disposed at a specified relative position. Therefore, the timepiece movement can be easily assembled.

A timepiece movement according to a sixth aspect of the application is the timepiece movement according to any one of the above first to fifth aspect, in which a yield stress of at least one of the slider spacers, the slider, the click body, and the biasing member may be larger than a yield stress of the barrel bridge.

According to the sixth aspect, when the yield stress of the slider spacer is larger than the yield stress of the barrel bridge, the slider spacer can have hardness higher than that of the barrel bridge and be less likely to wear. Accordingly, as compared with a configuration in which a groove or the like that guides the rotation of the guided portion around the rotation axis is formed in the barrel bridge instead of the slider spacer, it is possible to improve the wear resistance of the timepiece movement against the rotation of the click body around the rotation axis. In addition, when the yield stress of any member of the slider, the click body, and the biasing member is larger than the yield stress of the barrel bridge, the member can have hardness higher than that of the barrel bridge and be less likely to wear. Accordingly, the wear resistance of the timepiece movement can be further improved.

A timepiece movement according to a seventh aspect of the application is the timepiece movement according to any one of the above first aspect to sixth aspect, in which the barrel bridge may include a positioning portion configured to restrict approach of the biasing member toward the slider.

According to the seventh aspect, by bringing the biasing member into contact with the positioning portion in a constantly biased state, a variation in gap between the biasing member and the slider can be prevented, and an operation of the slider and the click body can be stabilized. Further, since the positioning portion is provided on the barrel bridge, the number of parts can be reduced as compared with the case where the positioning portion is provided separately from the barrel bridge.

A timepiece according to an eighth aspect of the application includes the timepiece movement according to any one of the above first aspect to seventh aspect.

According to the eighth aspect, it is possible to provide a timepiece having an excellent appearance and accuracy and having high reliability of preventing wear of a part.

According to the application, it is possible to provide a timepiece movement capable of preventing transmission of an excessive torque from a mainspring to an escapement and speed control mechanism and preventing wear of a part without deteriorating an appearance of the movement, and a timepiece including the timepiece movement.

### BRIEF DESCRIPTION OF THE DRAWINGS

FIG. 1 is an appearance diagram of a timepiece according to a first embodiment.

FIG. 2 is a plan view of a movement according to the first embodiment as viewed from above.

FIG. 3 is a cross-sectional view taken along a line III-III in FIG. 2.

FIG. 4 is an exploded perspective view of a barrel bridge, a click unit, and a click spring according to the first embodiment.

FIG. 5 is a bottom view of the barrel bridge, the click unit, and the click spring according to the first embodiment.

FIG. 6 is a perspective view of the click unit according to the first embodiment.

FIG. 7 is an exploded perspective view of the click unit according to the first embodiment.

FIG. 8 is an enlarged plan view of the movement showing a periphery of a ratchet wheel according to the first embodiment.

FIG. 9 is a plan view of the movement showing an operation of the click unit according to the first embodiment.

FIG. 10 is a perspective view of a click unit according to a second embodiment.

FIG. 11 is an exploded perspective view of the click unit according to the second embodiment.

FIG. 12 is a perspective view of a click unit according to a third embodiment.

FIG. 13 is an exploded perspective view of the click unit according to the third embodiment.

FIG. 14 is a perspective view of a click unit and a click spring according to a fourth embodiment.

FIG. 15 is a plan view showing a part of a click unit according to a fifth embodiment.

FIG. 16 is a cross-sectional view of a movement according to a sixth embodiment and is an enlarged view of a periphery of a click unit.

### DETAILED DESCRIPTION OF THE PREFERRED EMBODIMENTS

Hereinafter, embodiments of the invention will be described with reference to the drawings. Note that, in the following description, components having the same or similar functions are denoted by the same reference signs. Duplicate description of these configurations may be omitted. In the present embodiment, a mechanical timepiece will be described as an example of a timepiece.

In general, a machine body including a driving portion of the timepiece is referred to as a “movement”. A state where a dial and hands are attached to the movement and the obtained product is put into a timepiece case to form a finished product is referred to as a “complete” timepiece. A rotation axis direction of the hands is referred to as an axial direction. Description will be made with a direction from a main plate, which is a substrate of the timepiece, toward a case back being an upper side (or a front side) and an opposite side thereof being a lower side (or a back side) in the axial direction. A direction orthogonal to the axial direction is referred to as an in-plane direction. Note that, in the present embodiment, a rotation direction around an axis along the axial direction will be described in a direction viewed from above.

### First Embodiment

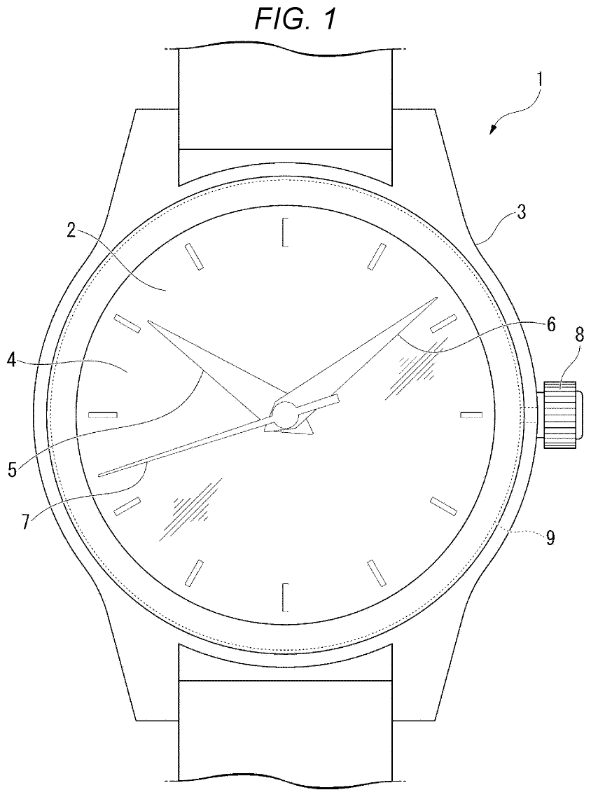

FIG. 1 is an appearance diagram of a timepiece according to a first embodiment.

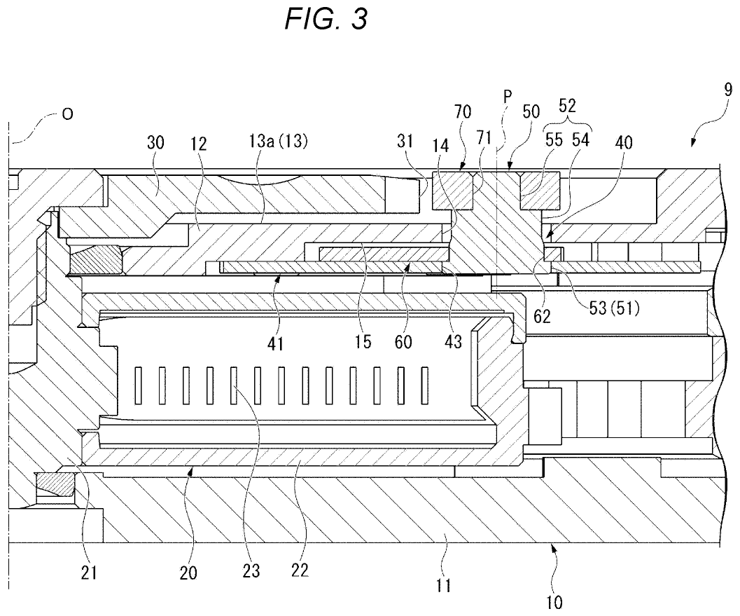

As shown in FIG. 1, a complete timepiece 1 according to the present embodiment includes a movement 9 (timepiece movement), a dial 4, and hands including an hour hand 5, a minute hand 6, and a second hand 7 in a timepiece case 3 including a case back (not shown) and a glass 2. In the timepiece 1, a mainspring 23 (see FIG. 3) can be manually wound, and the mainspring 23 is wound via a manual winding train wheel by rotating a crown 8.

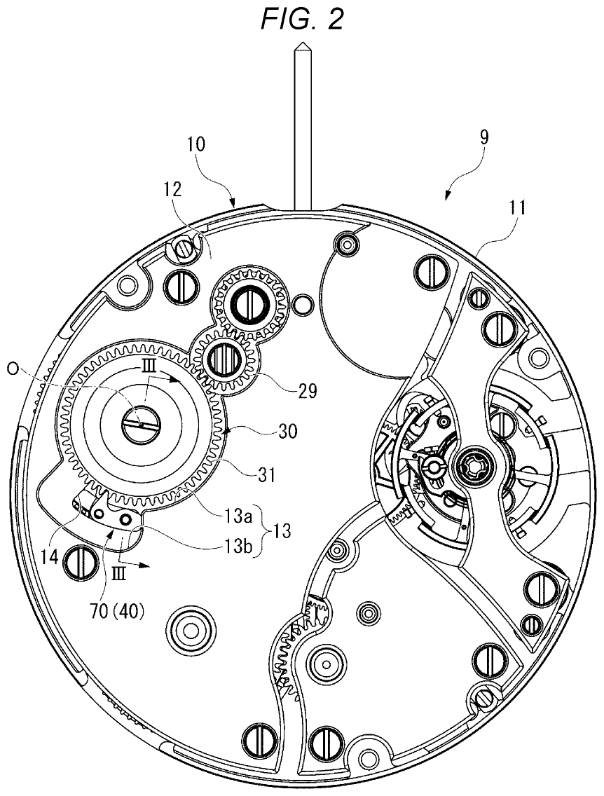

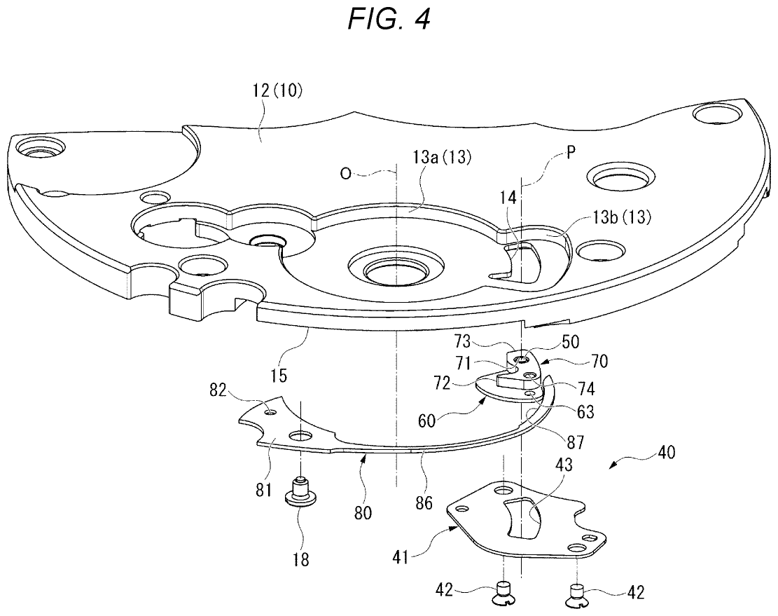

FIG. 2 is a plan view of the movement according to the first embodiment as viewed from above. FIG. 3 is a cross-sectional view taken along a line III-III in FIG. 2. FIG. 4 is an exploded perspective view of a barrel bridge, a click unit, and a click spring according to the first embodiment.

As shown in FIGS. 2 to 4, the movement 9 includes a support member 10, a barrel complete 20, a ratchet wheel 30, a click unit 40, and a click spring 80. Note that, the movement 9 includes a front train wheel including the barrel complete 20, a center wheel and pinion, a third wheel and pinion, or a fourth wheel and pinion, and an escapement and speed control mechanism including a balance with hairspring, an escape wheel and pinion, or a pallet fork, but detailed description thereof is omitted.

As shown in FIGS. 2 and 3, the support member 10 is a so-called main plate 11 and a bridge. The support member 10 supports a rotating body included in the movement 9. The rotating body includes the barrel complete 20, the front train wheel, the escapement and speed control mechanism, and the like. The support member 10 includes the main plate 11 and a barrel bridge 12 disposed above (on a case back side of) the main plate 11. The main plate 11 and the barrel bridge 12 support the barrel complete 20 rotatably around a rotation axis O extending in the axial direction. The main plate 11 and the barrel bridge 12 are formed of a metal material. In the present embodiment, the main plate 11 and the barrel bridge 12 are formed of a metal material such as brass.

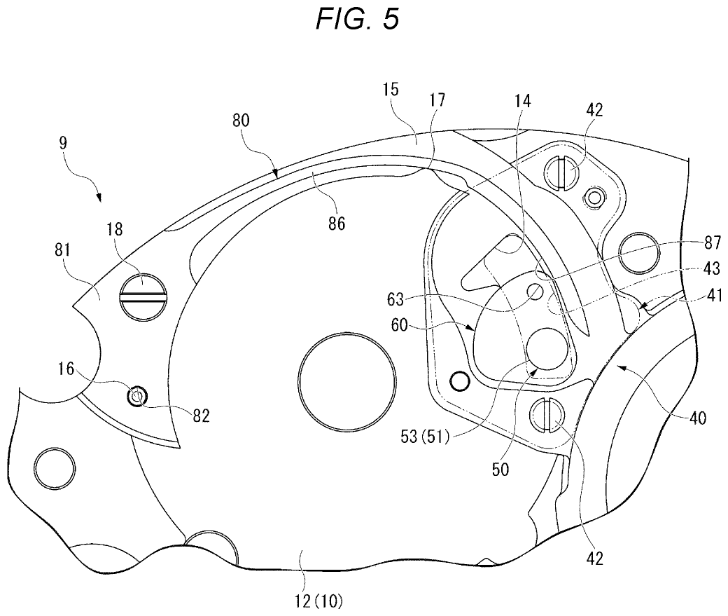

FIG. 5 is a bottom view of the barrel bridge, the click unit, and the click spring according to the first embodiment. Note that, in FIG. 5, a slider spacer 41 is indicated by an imaginary line.

As shown in FIGS. 4 and 5, the barrel bridge 12 includes an upper surface recess 13, a lower surface recess 15, and a penetration portion 14 (through hole). The penetration portion 14 penetrates the barrel bridge 12 in the axial direction. The penetration portion 14 is formed to be larger than a click body 70 to be described later when viewed from the axial direction. The upper surface recess 13 is formed in an upper surface of the barrel bridge 12 and is recessed downward. The upper surface recess 13 includes a ratchet wheel housing portion 13a that houses the ratchet wheel 30, and a click housing portion 13b that is continuous with the ratchet wheel housing portion 13a and that houses the click body 70. The penetration portion 14 is open in a bottom surface of the click housing portion 13b.

As shown in FIG. 5, the lower surface recess 15 is formed in a lower surface of the barrel bridge 12 and is recessed upward. The penetration portion 14 is open in a bottom surface of the lower surface recess 15. A guide pin 16 protrudes from the bottom surface of the lower surface recess 15. A positioning portion 17 is formed on a side surface of the lower surface recess 15. The positioning portion 17 is positioned to define the lower surface recess 15 from a rotation axis O side. The positioning portion 17 bulges to a side opposite the rotation axis O when viewed from the axial direction.

As shown in FIG. 3, the barrel complete 20 includes a barrel stem 21, a barrel 22 attached to the barrel stem 21, and the mainspring 23 housed in the barrel 22. The barrel stem 21 is supported by the main plate 11 and the barrel bridge 12 so as to be rotatable around the rotation axis O. The barrel 22 is disposed between the main plate 11 and the barrel bridge 12. The barrel 22 is rotatably supported by the barrel stem 21. An inner end portion of the mainspring 23 is connected to the barrel stem 21. An outer end portion of the mainspring 23 is connected to an inner peripheral surface of the barrel 22. The mainspring 23 is wound by the rotation of the barrel stem 21. The barrel 22 is rotated by a restoring force when the mainspring 23 is unwound, and drives the front train wheel.

As shown in FIGS. 2 and 3, the ratchet wheel 30 is disposed coaxially with the barrel complete 20. The ratchet wheel 30 is provided to be integrally rotatable with the barrel stem 21. The ratchet wheel 30 is rotatably supported by the barrel bridge 12 via the barrel stem 21. The ratchet wheel 30 is disposed on a side opposite to the barrel 22 (that is, on an upper side) with the barrel bridge 12 interposed therebetween. The ratchet wheel 30 is disposed in the ratchet wheel housing portion 13a. The ratchet wheel 30 winds the mainspring 23 housed in the barrel 22 by rotating integrally with the barrel stem 21 in a clockwise direction. A torque in a counterclockwise direction acts on the ratchet wheel 30 due to the restoring force when the mainspring 23 is unwound. Teeth 31 are formed on an outer peripheral portion of the ratchet wheel 30. The manual winding train wheel is connected to the ratchet wheel 30.

In the illustrated example, the ratchet wheel 30 meshes with an intermediate wheel 29 that transmits rotation of a crown wheel of the manual winding train wheel to the ratchet wheel 30.

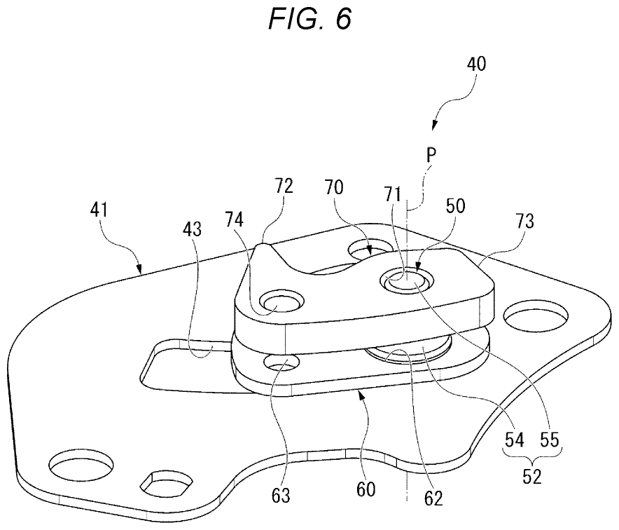

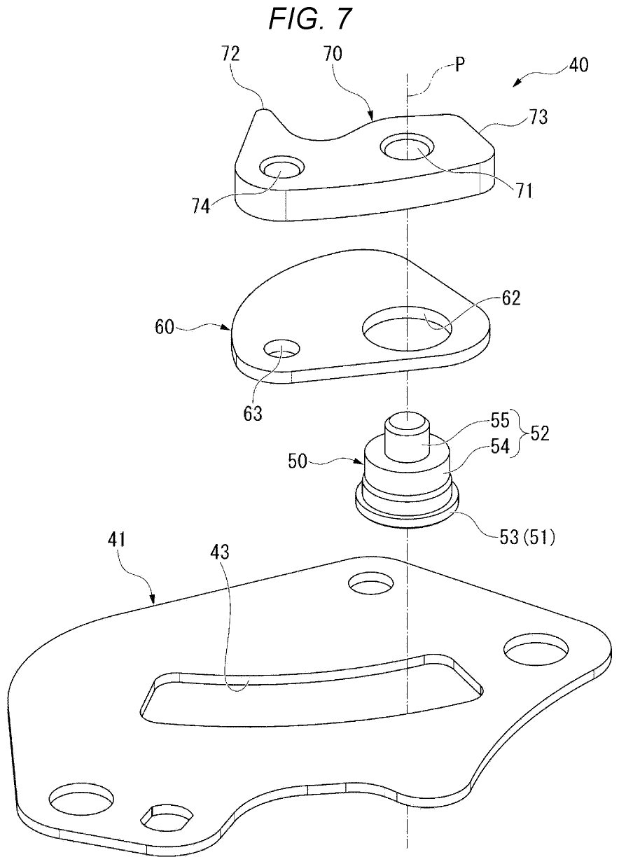

FIG. 6 is a perspective view of the click unit according to the first embodiment. FIG. 7 is an exploded perspective view of the click unit according to the first embodiment.

As shown in FIGS. 6 and 7, the click unit 40 includes the slider spacer 41, a slider 60, a pin 50, and the click body 70.

The slider spacer 41 is provided separately from the support member 10. The slider spacer 41 is formed of, for example, a metal material such as iron or stainless steel in a plate shape with front and rear surfaces facing the axial direction. The slider spacer 41 is disposed on a side opposite the ratchet wheel 30 with the barrel bridge 12 interposed therebetween. The slider spacer 41 is disposed between the main plate 11 and the barrel bridge 12. The slider spacer 41 is disposed to overlap the barrel complete 20 when viewed from the axial direction. The slider spacer 41 is disposed in the lower surface recess 15 formed in the lower surface of the barrel bridge 12 so as not to protrude below the barrel bridge 12 (see FIG. 3). The slider spacer 41 is disposed to be non-displaceable with respect to the support member 10. The slider spacer 41 is fastened and fixed to the barrel bridge 12 by screws 42 inserted from a lower side (see FIG. 4).

The slider spacer 41 is formed with a guide groove 43 extending along a circumferential direction around the rotation axis O (hereinafter, simply referred to as a circumferential direction). The guide groove 43 opens on an upper surface of the slider spacer 41. In the present embodiment, the guide groove 43 penetrates the slider spacer 41 in the axial direction. The guide groove 43 extends with a constant width. The guide groove 43 overlaps the penetration portion 14 of the barrel bridge 12 when viewed from the axial direction. At least a part of a side wall surface of the guide groove 43 overlaps a side wall surface of the penetration portion 14 when viewed from the axial direction or overlaps the barrel bridge 12 outside the penetration portion 14.

The slider 60 is disposed along the slider spacer 41. The slider 60 is disposed between the barrel bridge 12 and the slider spacer 41. The slider 60 is formed of, for example, a metal material such as iron or stainless steel in a flat plate shape with front and rear surfaces facing the axial direction. The slider 60 overlaps the barrel bridge 12 and the slider spacer 41 when viewed from the axial direction. The slider 60 is formed with a pin hole 62 and a positioning recess 63. The pin hole 62 penetrates the slider 60 in the axial direction. The pin 50 is inserted into the pin hole 62 from below. The positioning recess 63 opens in an upper surface of the slider 60 toward the click body 70. In the present embodiment, the positioning recess 63 penetrates the slider 60 in the axial direction. The positioning recess 63 has a circular shape when viewed from the axial direction. The positioning recess 63 is at a position shifted from the pin hole 62 in the clockwise direction.

The slider 60 is formed in a fan shape centered on the pin hole 62 when viewed from the axial direction. The slider 60 is formed to expand from the pin hole 62 at least in the clockwise direction and toward the rotation axis O. In the case where the pin hole 62 is used as a reference, the clockwise direction and the rotation axis O side coincide with a meshing portion side between the click body 70 and the ratchet wheel 30 when viewed from the axial direction. The slider 60 is formed such that a portion positioned on the meshing portion side between the click body 70 and the ratchet wheel 30 overlaps the slider spacer 41, with reference to the pin hole 62 when viewed from the axial direction.

The pin 50 is formed of, for example, a metal material such as iron or stainless steel in a columnar shape. The pin 50 has a central axis P extending along the axial direction. The pin 50 penetrates the pin hole 62 of the slider 60 and protrudes to both upper and lower sides of the slider 60. The pin 50 is fixed to the slider 60 by being press-fitted into the pin hole 62. Note that, the pin 50 may be fixed to the slider 60 by, for example, adhesion or fitting instead of press-fitting. The pin 50 includes a downward protrusion 51 protruding downward from the slider 60 and an upward protrusion 52 protruding upward from the slider 60.

The downward protrusion 51 is inserted into the guide groove 43 of the slider spacer 41 from above. The downward protrusion 51 is provided so as not to protrude downward from the slider spacer 41. However, the downward protrusion 51 may protrude downward from the slider spacer 41. The downward protrusion 51 is positioned at a counterclockwise end portion of the guide groove 43. The downward protrusion 51 includes a flange 53 that protrudes outward in a radial direction and that continuously extends over the entire circumference. The flange 53 is formed in a circular ring shape around the central axis P. The flange 53 is positioned on an inner side of the guide groove 43. An outer diameter of the flange 53 substantially coincides with the width of the guide groove 43. Accordingly, the pin 50 can rotate around the central axis P in the guide groove 43, and the slider 60 can rotate around the central axis P with respect to the slider spacer 41. An upper surface of the flange 53 faces a lower surface of the slider 60. The downward protrusion 51 is movable in the guide groove 43 along an extending direction of the guide groove 43 and rotates around the rotation axis O along the guide groove 43. The downward protrusion 51 of the pin 50 comes into contact with the slider spacer 41 in an end portion of the guide groove 43 in the circumferential direction, thereby restricting the movement in the circumferential direction.

The upward protrusion 52 is inserted through the penetration portion 14 of the barrel bridge 12. Note that, the upward protrusion 52 is not in contact with the barrel bridge 12. The upward protrusion 52 includes a large diameter portion 54 and a small diameter portion 55 that are vertically adjacent to each other. The large diameter portion 54 is positioned on an inner side of the penetration portion 14 of the barrel bridge 12. An outer diameter of the large diameter portion 54 is larger than an outer diameter of the small diameter portion 55. The small diameter portion 55 is positioned above the large diameter portion 54. The small diameter portion 55 includes an upper end portion of the pin 50.

The click body 70 is disposed on the same side as the ratchet wheel 30 in the axial direction with respect to the barrel bridge 12. The click body 70 is formed of, for example, a metal material such as iron or stainless steel. The click body 70 has an axis hole 71 into which the pin 50 is press-fitted, and is fixed to the pin 50. Accordingly, the click body 70 is rotatable around the central axis P together with the slider 60 and the pin 50 with respect to the slider spacer 41. The click body 70 is externally inserted around the small diameter portion 55 of the upward protrusion 52 of the pin 50 and is seated on an upper end surface of the large diameter portion 54. The click body 70 is formed smaller than the penetration portion 14 of the barrel bridge 12 when viewed from the axial direction. More specifically, the entire the click body 70 has a size that fits inside the side wall surface of the penetration portion 14 when viewed from the axial direction. Accordingly, the click body 70 can pass through the penetration portion 14 along the axial direction.

The click body 70 is formed with a positioning hole 74. The positioning hole 74 penetrates the click body 70 in the axial direction. The positioning hole 74 is at a position shifted from the axis hole 71 in the clockwise direction. The positioning hole 74 has the same shape and the same size as the positioning recess 63 of the slider 60 when viewed from the axial direction. The positioning hole 74 coincides with the positioning recess 63 when viewed from the axial direction.

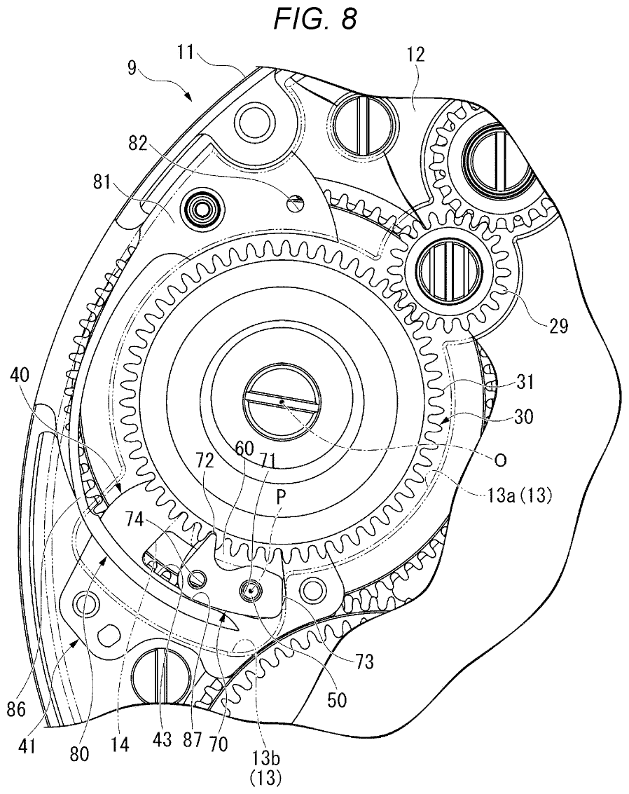

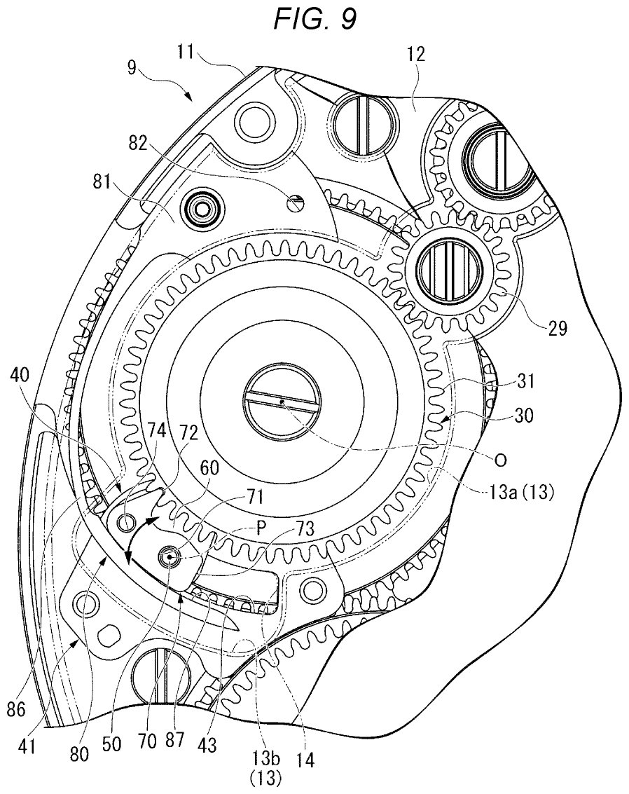

FIG. 8 is an enlarged plan view of the movement showing a periphery of the ratchet wheel according to the first embodiment. Note that, in FIG. 8, a part of the barrel bridge 12 is indicated by an imaginary line in order to make components of the movement 9 easy to see (the same applies to FIG. 9).

As shown in FIG. 8, the click body 70 extends from the central axis P of the pin 50 to both sides in the circumferential direction. The click body 70 includes a finger portion 72 and a contact portion 73. The finger portion 72 meshes with the ratchet wheel 30. The finger portion 72 is provided in the clockwise direction with respect to the pin 50. The finger portion 72 protrudes toward the rotation axis O. The finger portion 72 is tapered when viewed from the axial direction so as to enter a tooth groove between the pair of teeth 31 of the ratchet wheel 30. The contact portion 73 is an end surface of the click body 70 in the counterclockwise direction. The contact portion 73 is formed to be in surface contact with a side wall surface of the click housing portion 13b in a state where the pin 50 is positioned in a vicinity of the counterclockwise end portion of the guide groove 43. When the click body 70 is pressed in the counterclockwise direction, the contact portion 73 comes into surface contact with the side wall surface of the click housing portion 13b to restrict rotation of the click body 70 around the pin 50. Note that, the click body 70 does not come into contact with the barrel bridge 12 except for the contact portion 73 in a state (predetermined posture) where the central axis P of the pin 50 is parallel to the axial direction. In addition, when the click body 70 is inclined from the predetermined posture together with the pin 50 and the slider 60, and in a state where the slider 60 is in contact with at least one of the lower surface of the barrel bridge 12 and the upper surface of the slider spacer 41 and is restricted from being further inclined, the click body 70 does not come into contact with the barrel bridge 12 except for the contact portion 73.

The slider spacer 41, the slider 60, and the click body 70 are formed of a metal material such as iron or stainless steel. It is desirable that the slider spacer 41, the slider 60, and the click body 70 are made of a material having a yield stress higher than that of the barrel bridge 12. The yield stress of the slider spacer 41, the slider 60, and the click body 70 is preferably 500 MPa or more, and more preferably 1000 MPa or more. Further, it is desirable that an outer surface of a member in sliding contact with the barrel bridge 12 is provided with a treatment layer having wear resistance higher than that of the base material of the member. Note that, the slider spacer 41, the slider 60, and the click body 70 may be formed of ceramics. In addition, at least one of the slider 60 and the click spring 80 may be formed with a hard film having excellent wear resistance such as DLC (diamond-like carbon) at a portion in sliding contact with the other.

The click spring 80 is provided to be capable of pressing the slider 60 toward the rotation axis O so as to bias the finger portion 72 of the click body 70 toward the ratchet wheel 30. The click spring 80 is disposed on the same side (lower side) as the slider 60 in the axial direction with respect to the barrel bridge 12. The click spring 80 is disposed along the lower surface of the barrel bridge 12. The click spring 80 is disposed in the lower surface recess 15 of the barrel bridge 12. The click spring 80 is supported by the barrel bridge 12 in a cantilever manner. The click spring 80 includes a fixed portion 81 fixed to the barrel bridge 12 and a spring portion 86 extending from the fixed portion 81 and formed to be deflectable and deformable, which are integrally formed with each other. The fixed portion 81 is disposed at a position in the clockwise direction with respect to the click body 70. The fixed portion 81 is formed with a pin hole 82 into which the guide pin 16 is inserted. The fixed portion 81 is fixed to the barrel bridge 12 in the axial direction by a locking screw 18.

The spring portion 86 extends along the counterclockwise direction from the fixed portion 81 toward the slider 60. The spring portion 86 is in elastic contact with the positioning portion 17 of the barrel bridge 12 from a side opposite to the rotation axis O. A tip end portion of the spring portion 86 is disposed between the barrel bridge 12 and the slider spacer 41 at a position in the counterclockwise direction with respect to a contact portion between the spring portion 86 and the positioning portion 17. The tip end portion of the spring portion 86 is disposed on a side opposite to the rotation axis O with the slider 60 interposed therebetween. The tip end portion of the spring portion 86 is restricted from approaching the slider 60 positioned on the rotation axis O side by the spring portion 86 coming into contact with the positioning portion 17. The tip end portion of the spring portion 86 has a sliding contact surface 87 facing the rotation axis O side. The sliding contact surface 87 extends along the circumferential direction. The sliding contact surface 87 has a gap that allows contact with the slider 60 that swings around the pin 50.

FIG. 9 is a plan view of the movement showing an operation of the click unit according to the first embodiment.

An operation of the click body 70 will be described with reference to FIGS. 8 and 9. Note that, in the following description, a movement of the click body 70 around the pin 50 is referred to as swing, and a movement of the click body 70 around the rotation axis O is referred to as rotation.

When the ratchet wheel 30 is rotated in the clockwise direction in winding the mainspring 23, a force in the clockwise direction is applied to the click body 70 via the finger portion 72. At this time, when the click body 70 attempts to swing in the counterclockwise direction integrally with the slider 60 such that the finger portion 72 is separated from the tooth groove of the ratchet wheel 30, the slider 60 comes into contact with the click spring 80 and is pressed toward the rotation axis O. Therefore, the click body 70 is biased toward the ratchet wheel 30, and a state where the finger portion 72 meshes with the ratchet wheel 30 is maintained.

Here, since the click body 70 is provided to be non-displaceable with respect to the slider 60, as the pin 50 is guided by the guide groove 43 of the slider spacer 41 and moves in the guide groove 43, the pin 50, together with the slider 60 fixed to the pin 50, rotates in the clockwise direction. At this time, an outer peripheral surface of the downward protrusion 51 of the pin 50 (an outer peripheral surface of the flange 53 in the present embodiment) slides on the side wall surface of the guide groove 43. The click body 70 does not come into contact with the barrel bridge 12 during the rotation.

When the pin 50 reaches a vicinity of a clockwise end portion of the guide groove 43 along with the rotation of the ratchet wheel 30 in the clockwise direction, the rotation of the click body 70 in the clockwise direction is restricted. In this state, when the ratchet wheel 30 is further rotated in the clockwise direction, the click body 70 swings in the counterclockwise direction so as to separate the finger portion 72 from the tooth groove of the ratchet wheel 30. On the other hand, when the click body 70 swings in the counterclockwise direction integrally with the slider 60, the click spring 80 comes into contact with the slider 60 to press the slider 60 toward the rotation axis O, and the click body 70 is biased toward the ratchet wheel 30. Therefore, when the finger portion 72 climbs over a tooth tip of the ratchet wheel 30, the click body 70 swings in the clockwise direction such that the finger portion 72 enters the tooth groove. In this way, when the ratchet wheel 30 is rotated in the clockwise direction, the click body 70 swings back and forth such that the finger portion 72 climbs over the teeth 31 of the ratchet wheel 30 one by one (see FIG. 9). When the click body 70 swings in this way, the outer peripheral surface of the pin 50 slides on a side wall surface of the guide groove 43.

The click spring 80 comes into contact with the slider 60 when the finger portion 72 swings to climb over the teeth 31 of the ratchet wheel 30 regardless of a position of the click body 70 in the circumferential direction. In addition, the click spring 80 has a gap with the slider 60 in at least a part of a state where the finger portion 72 meshes with the ratchet wheel 30 and the click body 70 rotates. In the present embodiment, the click spring 80 has a gap with the slider 60 in a state where the click body 70 is positioned at a counterclockwise end portion in a rotation range and the finger portion 72 meshes with the ratchet wheel 30 (see FIG. 8). The click spring 80 has a gap with the slider 60 in a state where the click body 70 is positioned at a clockwise end portion in the rotation range and the finger portion 72 meshes with the ratchet wheel 30 (see FIG. 9). That is, the slider 60 has a gap with the click spring 80 in the entire process in which the finger portion 72 meshes with the ratchet wheel 30 and the click body 70 rotates. However, in the process in which the finger portion 72 meshes with the ratchet wheel 30 and the click body 70 rotates in the clockwise direction, the slider 60 may shift from a state of being allowed to be separated from the click spring 80 to a state of being forcibly brought into contact with the click spring 80.

When winding of the mainspring 23 is stopped, a torque in the counterclockwise direction acts on the ratchet wheel 30 by a restoring force of unwinding of the mainspring 23. Then, the ratchet wheel 30 starts to reversely rotate in the counterclockwise direction. At this time, as in the case of winding the mainspring 23, since a state where the finger portion 72 meshes with the ratchet wheel 30 by the click spring 80 is maintained, the click body 70 rotates in the counterclockwise direction together with the slider 60 along with the reverse rotation of the ratchet wheel 30.

When the pin 50 reaches the vicinity of the counterclockwise end portion of the guide groove 43 along with the reverse rotation of the ratchet wheel 30 in the counterclockwise direction, the contact portion 73 of the click body 70 comes into surface contact with the side wall surface of the click housing portion 13b. At this time, since the contact portion 73 is pressed against the side wall surface of the click housing portion 13b in the counterclockwise direction by the ratchet wheel 30, the swing of the click body 70 is restricted. Accordingly, the state where the finger portion 72 meshes with the ratchet wheel 30 is maintained, thereby restricting the rotation of the ratchet wheel 30 in the counterclockwise direction.

As described above, the movement 9 according to the present embodiment includes: the slider spacer 41 disposed to be non-displaceable with respect to the barrel bridge 12 and formed with the guide groove 43 extending along a circumferential direction centered on the rotation axis O; the pin 50 inserted into the guide groove 43 and provided to be displaceable along the circumferential direction along the guide groove 43; the slider 60 disposed along the slider spacer 41, fixed to the pin 50, and provided to be rotatable around the central axis P with respect to the barrel bridge 12; the click body 70 provided to be non-displaceable with respect to the slider 60 and including the finger portion 72 meshing with the ratchet wheel 30; and the click spring 80 provided to be capable of pressing the slider 60 so as to bias the finger portion 72 toward the ratchet wheel 30. According to this configuration, when the ratchet wheel 30 is rotated in winding the mainspring 23, a force in a rotation direction of the ratchet wheel 30 is applied to the click body 70 via the finger portion 72. Here, since the click body 70 is provided to be non-displaceable with respect to the slider 60, as the pin 50 is guided by the guide groove 43 and moves in the guide groove 43, the click body 70, together with the slider 60 fixed to the pin 50, rotates around the rotation axis O in the same direction as the ratchet wheel 30. When the winding of the mainspring 23 is stopped, a torque in a direction opposite the rotation direction during the winding acts on the ratchet wheel 30 by a restoring force of unwinding of the mainspring 23. Then, the ratchet wheel 30 starts to reversely rotate. At this time, along with the reverse rotation of the ratchet wheel 30, the click body 70, together with the slider 60, rotates around the rotation axis O in the same direction as the ratchet wheel 30. In this way, when the winding of the mainspring 23 is stopped, the reverse rotation of the ratchet wheel 30 is allowed by a length of the guide groove 43 together with the rotation of the click body 70, and thus it is possible to prevent transmission of an excessive torque from the mainspring 23 to an escapement and speed control mechanism.

Since the guide groove 43 that guides the rotation of the pin 50 around the rotation axis O is formed in the slider spacer 41, it is possible to prevent sliding contact between a component of the movement 9 and the barrel bridge 12 when the click body 70 rotates around the rotation axis O. Therefore, it is possible to improve the wear resistance of the movement 9 against the rotation of the click body 70 around the rotation axis O without changing a material or performing a surface treatment on the barrel bridge 12.

Further, since the click spring 80 presses the slider 60, shapes of the slider 60 and the click spring 80 can be determined regardless of a shape of the click body 70. Accordingly, the slider 60 and the click spring 80 can be formed in a shape less likely to wear.

With the above, in the movement 9 that can prevent the transmission of the excessive torque from the mainspring 23 to the escapement and speed control mechanism, it is possible to prevent the wear of the part without deteriorating an appearance thereof.

In addition, since the slider 60 and the click body 70 can be formed into the click unit 40, when the click unit 40 is scratched, it is possible to replace a worn part by replacement of the click unit 40 without replacing the barrel bridge 12. Therefore, after-sales service performance can be improved.

The slider 60 and the click spring 80 are disposed between the barrel bridge 12 and the slider spacer 41. According to this configuration, a portion where the slider 60 can slide with respect to the barrel bridge 12 and the slider spacer 41 along with the rotation of the slider 60 in the circumferential direction is positioned between the barrel bridge 12 and the slider spacer 41. In addition, a sliding contact portion between the slider 60 and the click spring 80 is positioned between the barrel bridge 12 and the slider spacer 41. Accordingly, even when lubrication is performed on the sliding portion between the barrel bridge 12 and the slider 60 and the sliding contact portion between the slider 60 and the click spring 80, it is possible to prevent an oil from leaking to an outer surface of the movement 9. Therefore, the deterioration of the appearance of the movement 9 can be prevented.

In addition, since the slider 60 for holding the pin 50 is disposed along the slider spacer 41, the slider 60 is prevented from being inclined with respect to the slider spacer 41, and the click body 70 can be prevented from unintentionally coming into sliding contact with an upper surface of the barrel bridge 12.

Further, since the slider 60 and the click spring 80 are less likely to be displaced relative to each other in the axial direction by being sandwiched between the barrel bridge 12 and the slider spacer 41, the slider 60 and the click spring 80 are less likely to disengage. Therefore, the disengagement of the slider 60 and the click spring 80 due to an impact applied to the movement 9 can be prevented.

Moreover, the slider spacer 41 is disposed on a lower side of the barrel bridge 12. According to this configuration, a portion where the slider 60 slides with respect to the barrel bridge 12 and the slider spacer 41 along with the rotation of the slider 60 in the circumferential direction is positioned on the lower side of the barrel bridge 12. Accordingly, it is possible to prevent the oil, which has been supplied to lubricate the sliding portion of the slider 60, from leaking to an upper side (front side) of the barrel bridge 12 on the appearance of the movement 9. Therefore, the deterioration of the appearance of the movement 9 can be prevented.

The click body 70 is disposed on a side opposite to the slider 60 and the click spring 80 with respect to the barrel bridge 12 in the axial direction. According to this configuration, when the click body 70 is disposed on the upper side of the barrel bridge 12, the slider 60 and the click spring 80 are disposed on the lower side of the barrel bridge 12. Accordingly, since the sliding portion between the slider spacer 41 and the slider 60 and the sliding contact portion between the slider 60 and the click spring 80 are positioned on the lower side of the barrel bridge 12, it is possible to sufficiently lubricate the sliding portion between the slider spacer 41 and the slider 60 and the sliding contact portion between the slider 60 and the click spring 80 while preventing the deterioration of the appearance due to the lubrication. Therefore, the wear resistance of the movement 9 can be further improved.

In addition, since the slider 60 and the click spring 80 are disposed on the lower side of the barrel bridge 12, it is easy to ensure a finished area on the upper side of the barrel bridge 12, and it is possible to improve an aesthetic appearance of the movement 9.

Further, since the click spring 80 is disposed on a side opposite to the ratchet wheel 30 with the barrel bridge 12 interposed therebetween, the click spring 80 does not interfere with the ratchet wheel 30, and the click spring 80 can be disposed to overlap the ratchet wheel 30 when viewed from the axial direction. Therefore, a degree of freedom in layout of the click spring 80 can be improved.

The pin 50 extends along the axial direction and couples the slider 60 and the click body 70. The barrel bridge 12 is formed with the penetration portion 14 through which the pin 50 is inserted. The penetration portion 14 is formed larger than the click body 70 when viewed from the axial direction such that the click body 70 is passable through the penetration portion 14 along the axial direction. According to this configuration, in a state where the slider 60 and the click body 70 are formed into a unit, the click body 70 passes through the penetration portion 14 and can be disposed on a side opposite to the slider 60 with respect to the barrel bridge 12. Therefore, the movement 9 can be easily assembled and disassembled.

The click body 70 is formed with the positioning hole 74 penetrating in the axial direction at a position shifted from the pin 50 in the circumferential direction. The slider 60 is formed with the positioning recess 63 opening toward the positioning hole 74 and overlapping the positioning hole 74 when viewed from the axial direction. According to this configuration, when the click body 70 and the slider 60 are to be coupled with each other via the pin 50, the positioning hole 74 and the positioning recess 63 overlap each other when viewed from the axial direction, so that the click body 70 and the slider 60 can be disposed at a specified relative position. Therefore, the movement 9 can be easily assembled.

A yield stress of the slider spacer 41 is larger than a yield stress of the barrel bridge 12. According to this configuration, the slider spacer 41 can have hardness higher than that of the barrel bridge 12 and be less likely to wear. Accordingly, as compared with a configuration in which a groove or an elongated hole that guides the rotation of the pin 50 around the rotation axis O is formed in the barrel bridge 12 instead of the slider spacer 41, it is possible to improve the wear resistance of the movement 9 against the rotation of the click body 70 around the rotation axis O. In addition, a yield stress of the slider 60, the click body 70, or the click spring 80 is larger than the yield stress of the barrel bridge 12. According to this configuration, the slider 60, the click body 70, and the click spring 80 can have hardness higher than that of the barrel bridge 12 and be less likely to wear. Accordingly, the wear resistance of the movement 9 can be further improved.

The barrel bridge 12 includes the positioning portion 17 that restricts approach of the click spring 80 toward the slider 60. According to this configuration, by bringing the click spring 80 into contact with the positioning portion 17 in a constantly biased state, a variation in gap between the click spring 80 and the slider 60 can be prevented, and an operation of the slider 60 and the click body 70 can be stabilized. Further, since the positioning portion 17 is provided on the barrel bridge 12, the number of parts can be reduced as compared with the case where the positioning portion 17 is provided separately from the barrel bridge 12.

In addition, the timepiece 1 according to the present embodiment includes the above movement 9, and thus it is possible to obtain a timepiece having an excellent appearance and accuracy and having high reliability of preventing wear of a part.

### Second Embodiment

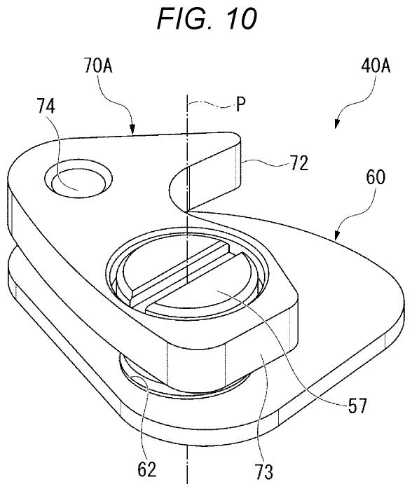

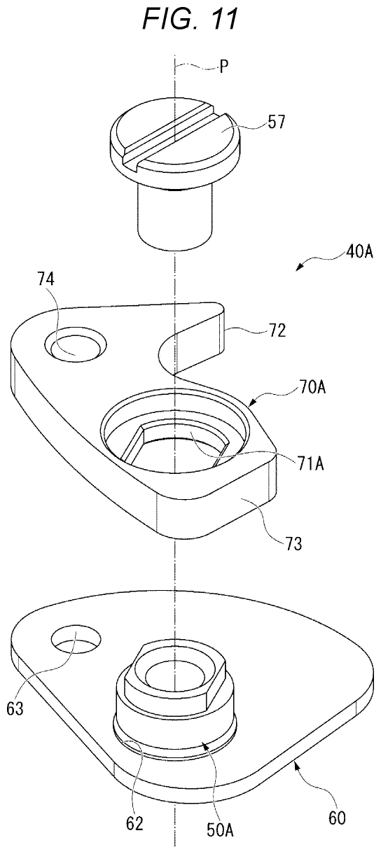

Next, a second embodiment will be described with reference to FIGS. 10 and 11. In the first embodiment, the pin 50 is press-fitted into the click body 70, to thereby fix the click body 70 to the pin 50. With respect to this, in the second embodiment, a click body 70A has a non-circular axis hole 71A, and a pin 50A is inserted into the axis hole 71A and non-rotatably engaged with the click body 70A. In this case, the click body 70A is fixed to the pin 50A in an axial direction by a click screw 57 screwed to an upper end portion of the pin 50A. Note that, other configurations are the same as those of the first embodiment.

In the present embodiment, effects similar to those of the first embodiment are achieved. In addition, according to the present embodiment, as compared with the case where the pin is press-fitted into the axis hole of the click body, an operation of assembling the click body to the pin is facilitated. Therefore, the movement 9 can be easily assembled.

### Third Embodiment

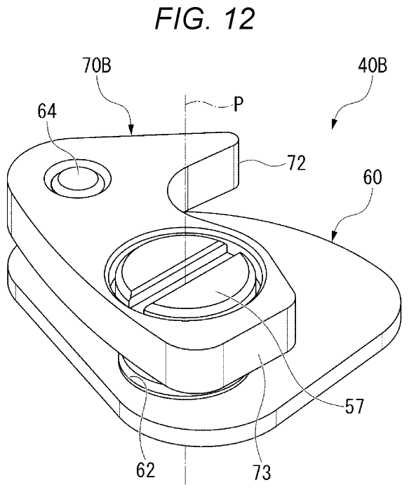

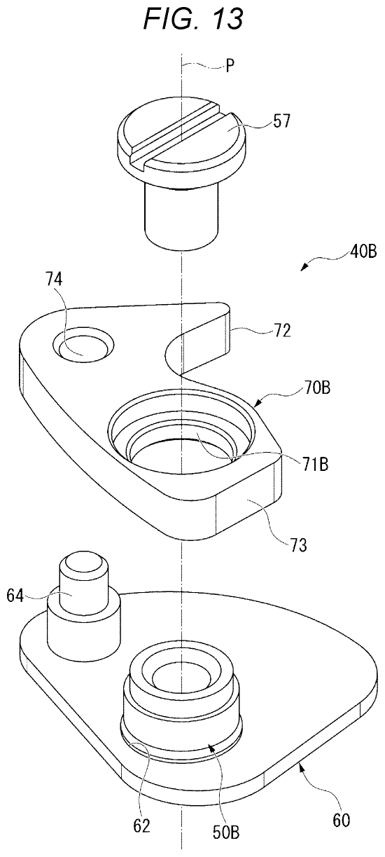

Next, a third embodiment will be described with reference to FIGS. 12 and 13. In the first embodiment, the pin 50 is press-fitted into the axis hole 71 of the click body 70, whereby the click body 70 cannot rotate around the central axis P with respect to the slider 60. With respect to this, the third embodiment is different from the first embodiment in that a click body 70B is engaged with the slider 60 at two portions to be non-rotatable with respect to the slider 60. Note that, configurations other than those to be described later are similar to those of the first embodiment.

A pin 50B is inserted into the axis hole 71B of the click body 70B from below. The click body 70B is fixed to the pin 50B in an axial direction by the click screw 57 screwed to an upper end portion of the pin 50B. The slider 60 includes a positioning protrusion 64 instead of the positioning recess 63 in the first embodiment. The positioning protrusion 64 is formed in a columnar shape and protrudes upward. The positioning protrusion 64 is inserted into the positioning hole 74 of the click body 70B from below. The positioning protrusion 64 is engaged with the click body 70B so as to restrict rotation of the click body 70B around the pin 50B (central axis P). In addition, the pin 50B is engaged with the click body 70B so as to restrict rotation of the click body 70B around the positioning protrusion 64 (positioning hole 74).

In the present embodiment, effects similar to those of the first embodiment are achieved. In addition, according to the present embodiment, as compared with the case where the pin is press-fitted into the axis hole of the click body, a positioning work of the click body 70B with respect to the slider 60 and a work of assembling the click body 70B to the pin 50B are facilitated. Therefore, the movement 9 can be easily assembled.

### Fourth Embodiment

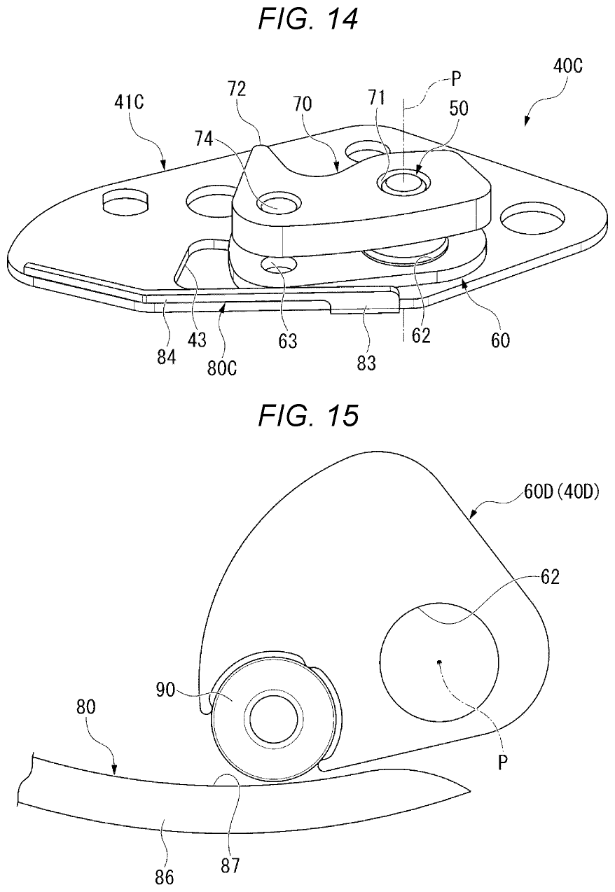

Next, a fourth embodiment will be described with reference to FIG. 14. The fourth embodiment is different from the first embodiment in that a click spring 80C is formed integrally with a slider spacer 41C. Note that, configurations other than those to be described later are similar to those of the first embodiment.

The click spring 80C is formed integrally with the slider spacer 41C by bending a base material of the slider spacer 41C. The click spring 80C is a leaf spring that is deflectable and deformable in an in-plane direction. The click spring 80C overlaps the slider 60 in the in-plane direction. The click spring 80C includes a base end portion 83 connected to an outer peripheral edge of the slider spacer 41C and a spring portion 84 extending from the base end portion 83 in the in-plane direction. The base end portion 83 is connected to a portion of the outer peripheral edge of the slider spacer 41C positioned on a side opposite to the rotation axis O (see FIG. 8 and the like) with the guide groove 43 interposed therebetween. The base end portion 83 protrudes from the slider spacer 41C toward the slider 60 (upper side) in an axial direction. The spring portion 84 extends from the base end portion 83 in a clockwise direction around the rotation axis O. The spring portion 84 has a gap that allows contact with the slider 60 that swings around the pin 50 regardless of the position of the slider 60.

In the present embodiment, effects similar to those of the first embodiment are achieved. In addition, according to the present embodiment, as compared with a configuration in which the click spring is provided as an independent part, the number of parts can be reduced and the number of assembly steps of the movement 9 can be reduced.

### Fifth Embodiment

Next, a fifth embodiment will be described with reference to FIG. 15. In the first embodiment, the portion of the slider 60 that comes into sliding contact with the click spring 80 is formed of a metal material. With respect to this, in the fifth embodiment, a slider 60D includes a sliding contact member 90 at a portion where the slider 60D is in sliding contact with the click spring 80. The sliding contact member 90 is formed of precious stone such as ruby or zirconia, or other ceramics. For example, the sliding contact member 90 is formed in a cylindrical shape or a columnar shape, and is held on an outer peripheral portion of the slider 60D. In this case, it is desirable that only the sliding contact member 90 of the slider 60D is in sliding contact with the click spring 80. Note that, other configurations are the same as those of the first embodiment.

In the present embodiment, effects similar to those of the first embodiment are achieved. In addition, according to the present embodiment, as compared with a configuration in which a metal portion of the slider is in sliding contact with the click spring, sliding resistance caused by displacement of the slider 60D can be reduced. Therefore, the click body 70 can be smoothly operated. In addition, wear of the slider 60D and the click spring 80 can be prevented.

### Sixth Embodiment

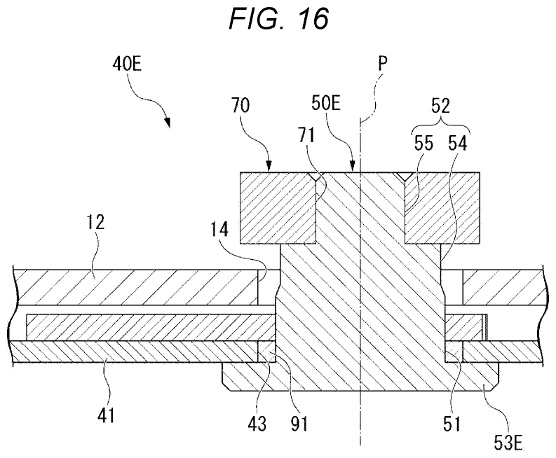

Next, a sixth embodiment will be described with reference to FIG. 16. In the first embodiment, the pin 50 is in sliding contact with the side wall surface of the guide groove 43 of the slider spacer 41. With respect to this, the sixth embodiment is different from the first embodiment in that a spacer 91 externally inserted around a pin 50E is in sliding contact with the side wall surface of the guide groove 43. Note that, configurations other than those to be described later are similar to those of the first embodiment.

The downward protrusion 51 of the pin 50E includes a flange 53E that protrudes from a lower end portion outward in a radial direction and that continuously extends over the entire circumference. The flange 53E is formed in a circular ring shape around a central axis P. The flange 53E is positioned below the slider spacer 41. An outer diameter of the flange 53E is larger than the width of the guide groove 43. An upper surface of the flange 53E faces a lower surface of a peripheral edge portion of the guide groove 43 in the slider spacer 41.

A click unit 40E further includes the spacer 91. The spacer 91 is formed of precious stone such as ruby or zirconia. The spacer 91 is formed in a cylindrical shape. An inner peripheral surface and an outer peripheral surface of the spacer 91 extend in an axial direction with a constant diameter, respectively. The spacer 91 is rotatably and externally inserted around the downward protrusion 51 of the pin 50E and is seated on an upper surface of the flange 53E from above. The spacer 91 is rotatably supported by the pin 50E. An outer diameter of the spacer 91 is smaller than the width of the guide groove 43. The spacer 91 is positioned on the inner side of the guide groove 43. The outer peripheral surface of the spacer 91 directly faces the side wall surface of the guide groove 43 and is in sliding contact with the side wall surface of the guide groove 43.

In the present embodiment, effects similar to those of the first embodiment are achieved. In addition, in the present embodiment, when the pin 50E is displaced in a circumferential direction in the guide groove 43, the spacer 91 externally inserted around the pin 50E can be brought into sliding contact with the side wall surface of the guide groove 43, and the spacer 91 can be rotated and rolled on the side wall surface of the guide groove 43. Accordingly, as compared with a configuration in which the pin is directly in sliding contact with the side wall surface of the guide groove 43, sliding resistance caused by displacement of the pin 50E in the circumferential direction can be reduced. Therefore, the click body 70 can be smoothly operated. In addition, wear of the pin 50E and the slider spacer 41 can be prevented.

Note that, in the sixth embodiment, the spacer 91 is rotatably and externally inserted around the pin 50E, but the spacer 91 may be fixed to the pin 50E. Even in this case, as compared with a configuration in which a metal-made pin is directly in sliding contact with the side wall surface of the guide groove 43, the sliding resistance caused by the displacement of the pin 50E in the circumferential direction can be reduced.

Note that, the invention is not limited to the embodiments described above with reference to the drawings, and various modifications are conceivable within the technical scope of the invention.

For example, in the above embodiments, the guide groove penetrates the slider spacer in the axial direction, but a guide groove may not penetrate a slider spacer in the first embodiment and the like.

In the above embodiments, the slider is formed in a fan shape in a plan view, but a shape of the slider is not particularly limited. For example, the slider may be formed in a rectangular shape in a plan view. However, it is desirable that the slider is formed to expand from the pin hole at least in the clockwise direction and toward the rotation axis O regardless of the shape in a plan view. Accordingly, when the click body is pulled by the ratchet wheel, the slider comes into contact with the slider spacer, and it is possible to prevent the slider from inclining. Therefore, it is also possible to prevent the pin and the click body from inclining from a predetermined posture, and it is also possible to prevent the click body from coming into contact with the barrel bridge.

In the above embodiments, the positioning portion that restricts the approach of the click spring toward the slider side is provided in the barrel bridge, but the invention is not limited to this configuration. The positioning portion may be provided separately from the barrel bridge, and may be, for example, a pin fixed to the barrel bridge.

In the above embodiments, the slider spacer is disposed on the back side of the barrel bridge, but the invention is not limited to this configuration. That is, the slider spacer may be disposed on the front side of the barrel bridge, and accordingly, the slider and the click spring may be disposed between the barrel bridge and the slider spacer on the front side of the barrel bridge.

In the above embodiments, the slider and the click spring are disposed on the back side of the barrel bridge, but the invention is not limited to this configuration. That is, the click body may be disposed on the back side of the barrel bridge, and the slider and the click spring may be disposed on the front side of the barrel bridge.

In the above embodiments, the pin protrudes upward and downward with respect to the slider, couples the slider and the click body, and is inserted into the guide groove of the slider spacer, but the invention is not limited to this configuration. The guided portion inserted into the guide groove and a coupling portion for coupling the slider and the click body may be provided as separate members.

In the first embodiment, the positioning recess of the slider penetrates the slider in the axial direction, but the positioning recess may not penetrate the slider as long as it opens toward the positioning hole of the click body. In addition, a positioning hole may be provided in the slider, and a positioning recess may be provided in the click body.

In the above embodiments, the click unit includes the slider spacer. However, the slider spacer may not be included in the click unit, and the click unit may include only parts (the slider, the pin, and the click body in the above embodiments) that can be operated integrally with each other.

In addition, components in the above embodiments can be appropriately replaced with well-known components without departing from the gist of the invention, and the above embodiments and modifications may be appropriately combined.

What is claimed is:

1. A timepiece movement comprising:
a ratchet wheel provided to be capable of winding a mainspring;
a barrel bridge configured to support the ratchet wheel to be rotatable around a rotation axis;
a slider spacer disposed to be non-displaceable with respect to the barrel bridge and formed with a guide groove extending along a circumferential direction centered on the rotation axis;
a guided portion inserted into the guide groove and provided to be displaceable along the circumferential direction along the guide groove;
a slider disposed along the slider spacer, fixed to the guided portion, and provided to be rotatable around an axis extending along an axial direction of the rotation axis with respect to the barrel bridge;
a click body provided to be non-displaceable with respect to the slider and including a finger portion meshing with the ratchet wheel; and
a biasing member provided to be capable of pressing the slider so as to bias the finger portion toward the ratchet wheel.

2. The timepiece movement according to claim 1, wherein
the slider and the biasing member are disposed between the barrel bridge and the slider spacer.

3. The timepiece movement according to claim 1, wherein
the click body is disposed on a side opposite the slider and the biasing member with respect to the barrel bridge in the axial direction.

4. The timepiece movement according to claim 3, wherein
the guided portion extends along the axial direction and couples the slider and the click body,
the barrel bridge is formed with a through hole through which the guided portion is inserted, and
the through hole is formed larger than the click body when viewed from the axial direction such that the click body is passable through the through hole along the axial direction.

5. The timepiece movement according to claim 1, wherein
the guided portion extends along the axial direction and couples the slider and the click body,
one of the click body and the slider is formed with a positioning hole penetrating the axial direction at a position shifted from the guided portion in a direction orthogonal to the axial direction, and
the other of the click body and the slider are formed with a positioning recess opening toward the positioning hole and overlapping the positioning hole when viewed from the axial direction.

6. The timepiece movement according to claim 1, wherein
a yield stress of at least one of the slider spacer, the slider, the click body, and the biasing member is larger than a yield stress of the barrel bridge.

7. The timepiece movement according to claim 1, wherein
the barrel bridge includes a positioning portion configured to restrict approach of the biasing member toward the slider.

8. A timepiece comprising:
the timepiece movement according to claim 1.
